(19) United States
(12) Patent Application Publication
(10) Pub. No.: US 2014/0217157 A1
(43) Pub. Date: Aug. 7, 2014

(54) REMOVAL OF ELECTRONIC CHIPS AND OTHER COMPONENTS FROM PRINTED WIRE BOARDS USING LIQUID HEAT MEDIA

(71) Applicant: Greene Lyon Group, Inc., Amesbury, MA (US)

(72) Inventors: Andre Brosseau, Montreal (CA); Svitlana Grigorenko, Montreal (CA)

(21) Appl. No.: 13/826,313

(22) Filed: Mar. 14, 2013

Related U.S. Application Data
(60) Provisional application No. 61/761,957, filed on Feb. 7, 2013.

(51) Int. Cl. B23K 1/018

(52) U.S. Cl. CPC B23K 1/018
USPC 228/264

(57) ABSTRACT

Systems and methods for the removal of electronic chips and other components from PWBs using liquid heat media are generally described. The systems and methods described herein can be used to remove solder, electronic chips (including those in which an integrated circuit is positioned on a piece of semiconductor material, such as silicon), and/or other electronic components from PWBs. In some such embodiments, the liquid heat medium may be at least partially separated from the solder and, in some cases, recycled back to a vessel in which the liquid heat medium is stored. The PWBs may be pre-heated, in some embodiments, prior to being immersed in a liquid heat transfer medium in which the solder is removed. In certain embodiments, an additional liquid heat medium may be used to remove underfill from PWBs. In certain embodiments, the electronic components separated from the PWBs may be at least partially separated according to size, density, and/or optical characteristics.

### RELATED APPLICATIONS

This application claims priority under 35 U.S.C. §119(e) to U.S. Provisional Patent Application Ser. No. 61/761,957, filed Feb. 7, 2013, and entitled “Removal of Electronic Chips and Other Components from Printed Wire Boards Using Liquid Heat Media,” which is incorporated herein by reference in its entirety for all purposes.

### TECHNICAL FIELD

Systems and methods for the removal of electronic chips and other components from printed wire boards using liquid heat media are generally described.

### BACKGROUND

The recovery of electronic chips and other components from the surface of printed wire boards (PWBs) is known. For example, such recovery can be performed via application of a heat gun or an infrared heater, as described in U.S. Pat. No. 5,552,579. Such recovery can also be performed by using a heating oven as in Japanese Patent JP11314084. In these patents, the surface of a PWB is heated in air so that the solder melts and the electronic components can be separated from the surface. Heating of PWBs in air can lead to volatilization of lead metal, so that lead atoms are transferred to the air and mixed with it, and the air becomes contaminated. Also, when heat guns or infrared heaters are used to heat the solder, the surface of PWB may be heated irregularly and certain parts of the PWB may become easily overheated. Overheating of plastic parts can lead to partial decomposition of plastics, whereby hazardous products of plastics decomposition (e.g., containing brominated and chlorinated flame retardants) are released to the air, creating contamination. The overheating of electronic components can result in thermal damage, so that the components cannot be recovered in working condition.

Attempts have been made to minimize the surface application of heat, e.g. by using heat bands (desoldering braids), which are generally applied directly and only to the solder (as described, for example, in U.S. Pat. No. 4,934,582) or by local application of hot gas (as in U.S. Pat. No. 5,769,989). One disadvantage of these methods is that they are generally highly labor intensive and generally cannot be applied for recycling large volumes of PWBs. Additionally, these methods do not prevent volatilization of solder metals, which creates air pollution.

A mixed fluid composed of metal particles and a liquid heat medium is used for the recovery of solder from PWBs in a special solder recovering apparatus described in U.S. Pat. No. 6,467,671 (“the '671 patent”). In the '671 patent, the fluid is sprayed onto the PWB kept at a temperature above the melting temperature of the solder, so that the solder alloy and the electronic components are scraped out of the surface of PWBs. According to the '671 patent, the specific gravity of each of the solder alloy, the metal particles, the liquid heat medium and electronic components should be selected as follows: solder alloy>metal particles>liquid heat medium>electronic components. As a result, the electronic components will float on the liquid heat medium layer and can be recovered; at the same time the solder alloy is transferred to the heavier solder alloy layer and can be recovered separately. Considering that the specific gravity of pure ceramics is around 4 g/cm³, and the electronic chips are made of ceramics and metals, the density of the liquid heat medium should be more than at least 4 g/cm³ for the process to work according to the '671 patent. The requirement that a liquid heat medium with such high density be used makes the utilization of the process described in the '671 patent problematic in many cases, as the densities of silicone oils, mineral oils, and the majority of petroleum oils are less than 1 g/cm³.

An article entitled “A new technology for recycling materials from waste printed circuit boards,” by Y. Zhou et al. (J. Haz. Mat. 175, pp. 823-828 (2010)) describes a process of “centrifugal separation+vacuum pyrolysis” for recycling PWBs. The Zhou article describes experiments performed in a closed reaction vessel, in which diesel oil is used as a heating medium for PWBs. However, as the flash point of the diesel oil is 62° C. and its auto ignition temperature is 210° C. (both of which are lower than the temperature required to melt lead-free solder), diesel oil is unlikely to be considered to be a safe heating medium for lead-free solder melting applications and many other solder melting applications. According to the Zhou article, the PWBs were cut into 10-15 cm² pieces and they were placed in a rotating basket, in which centrifugal force was used to separate the pieces of the PWBs and the electronic components. Cutting the PWBs into small pieces, as described in the Zhou article, would significantly reduce the throughput of a large scale recycling operation, making it economically inefficient in many cases. If the boards are cut into small pieces, it will also generally be highly labor consuming to separate pieces of bare boards from the desoldered electronic components at the end of the process. If the PWBs are not cut, a very large working volume of centrifuges would be needed in order to achieve industrial scale throughputs, especially for large boards. It should also be considered that the recovery of electronic components is not the final purpose of the process described in the Zhou article, but a first step of a two-stage recycling process, in which the recovered electronic components are pyrolyzed. The electronic components would not be recovered in working condition in such a process.

A method for dismounting through-hole electronic devices is described in U.S. Patent Application Publication No. 2010/0223775 (“the '775 patent application”). In the '775 patent application, the front surface of a PWB is exposed to an inert liquid so that the electronic device is dipped in that liquid and heated in a heating bath. The solder in the through-hole melts using the heat transferred from the electronic device. The '775 patent application describes the utilization of a fluorinated liquid as the inert liquid, which should be used in the heating bath. The majority of fluorinated liquids have a boiling point in the range of 30-215° C., and a flash point which is lower than the temperature needed to melt the solder. For example, the melting temperature of lead-free solder is 221° C. for Sn/Ag solder and 310-320° C. for high lead solder (Sn/Pb=3/97, 10/90, 5/95)). Accordingly, it is unlikely that the processes described in the '775 application can be operated safely for the removal of lead-free solder. The fluorinated liquids also do not represent a green choice of a liquid heat media as they have an ability to emit gaseous hydrogen fluoride at high temperatures (e.g., temperatures greater than 200° C.); the rinse water containing fluorinated liquids is not allowed to enter the drains and some fluorinated liquids are considered carcinogens. Also, the method of the '775 application is developed for recovery of individual electronic devices and would not be efficient for treatment of high volumes of PWBs, as is useful for the purposes of recycling.

A method for decapsulating a package is provided in U.S. Pat. No. 7,666,321 (“the '321 patent”), according to which a package consisting of a chip, a heat sink, a plurality of solder bumps, a substrate, an underfill, and a plurality of solder balls is processed. The process in the '321 patent includes the following steps: removing the heat sink, removing the substrate together with the solder balls, performing a dry etching process to remove a portion of the underfill, performing a wet etching process to remove the remaining portion of the underfill, performing a thermal process to melt the solder bumps and performing a solder bump removal process. The dry etching process in the '321 patent includes a reaction ion etching process and the wet etching process is performed with the use of a fuming nitric acid at 60-100° C. The '321 patent describes decapsulating a package for rework or failure analysis; for this process it is sometimes required to remove the underfill without removing solder, or to remove the solder bumps without damaging the underfill. The '321 patent describes a chain of operations to be applied to the individual package, and not to the plurality of electronic chips at the same time; accordingly, the process of the '321 patent will be too slow for most industrial recycling applications. For many recycling operations, a goal would be to provide fast recovery of all the electronic components, and there is often no need to decapsulate individual packages using a multi-stages process. There is also often no need to remove the underfill separate from removing the solder. Also, the use of hot fuming nitric acid makes the process of the '321 patent unsafe in many cases and can lead to the damage of electronic components if its contact with the board is not limited to the underfill.

Based on the above-referenced art, a green, safe, fast, and/or economically efficient process for recovery of electronic components from PWBs, both for re-use of working electronic components in the manufacture of new products and for recovery of metals value for recycling, is desirable.

### SUMMARY

The removal of electronic chips and other components from PWBs using liquid heat media, and associated systems and apparatus, are generally described. The subject matter of the present invention involves, in some cases, interrelated products, alternative solutions to a particular problem, and/or a plurality of different uses of one or more systems and/or articles.

One aspect relates to a process for the removal of electronic components attached to a surface of a printed wire board (PWB) with solder and/or an underfill. In some embodiments, the process comprises immersing the PWB in a liquid heat medium within a vessel at a temperature higher than the melting temperature of the solder such that the solder is melted, transporting at least a portion of the liquid heat medium and at least a portion of the solder out of the vessel, at least partially separating the solder from the liquid heat medium, and recycling at least a portion of the liquid heat medium to the vessel.

The process comprises, according to certain embodiments, immersing the PWB in a first liquid heat medium within a first vessel at a temperature higher than the melting temperature of the solder such that the solder is melted, and immersing the PWB in a second liquid heat medium within a second vessel at a temperature sufficiently high to remove the underfill.

In certain embodiments, the process comprises immersing the PWB in a first liquid heat medium within a first vessel at a first temperature, and immersing the PWB in a second liquid heat medium within a second vessel at a second temperature that is higher than the melting temperature of the solder such that the solder is melted, wherein the first temperature is between about 20% and about 80% of the second temperature, when the first and second temperatures are expressed in degrees Celsius.

In some embodiments, the process comprises immersing the PWB in a liquid heat medium at a temperature higher than the melting temperature of the solder, such that the solder melts and the electronic components detach from the surface of the PWB and at least partially separating the detached electronic components from each other according to sizes, densities, and/or optical characteristics of the electronic components.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1D are schematic illustrations showing various inventive parts of processes for the removal of electronic components from PWBs, according to certain embodiments;

FIG. 2 is a schematic illustration of a system for treating PWBs in a heating vessel and the separate recovery of solder, bare boards, and electronic components, according to one set of embodiments;

FIG. 3 is, according to certain embodiments, a flow diagram of a process for recycling PWBs;

FIG. 4 is, according to some embodiments, a schematic illustration of a cold filtration operation; and

FIG. 5 is a process flow diagram outlining the recovery of working electronic components from PWBs, according to some embodiments.

### DETAILED DESCRIPTION

Systems and methods for the removal of electronic chips and other components from PWBs using liquid heat media are generally described. The systems and methods described herein can be used to remove solder, electronic chips (including those in which an integrated circuit is positioned on a piece of semiconductor material, such as silicon), and/or other electronic components from PWBs. In some such embodiments, the liquid heat medium may be at least partially separated from the solder and, in some cases, recycled back to a vessel in which the liquid heat medium is stored. The PWBs may be pre-heated, in some embodiments, prior to being immersed in a liquid heat transfer medium in which the solder is removed. In certain embodiments, an additional liquid heat medium may be used to remove underfill from PWBs. In certain embodiments, the electronic components separated from the PWBs may be sorted according to size, density, and/or an optical characteristic.

According to one embodiment, a method is described for desoldering of electronic components from the surface of PWBs, such as motherboards, TV boards, RAM sticks, SCSI cards, cell phone boards, network cards, video cards, and the like, by removal of electronic chips, plastic connectors, capacitors, transistors, resistors, and/or other types of electronic devices, which have been attached to the surface of PWBs with the solder, by melting the solder in a liquid heat medium and optionally applying an external force in order to separate the electronic components from PWBs.

The recovered electronic components can be further used in at least two ways, according to certain embodiments:
1. In some embodiments, the recovered components can retain their functionality. After having been subjected to the main process, the electronic components (e.g., electronic chips) can be rinsed and an additional coat of solder can be applied to their pins in order to make sure each pin is covered by solder. The components can then be re-used in the manufacture of new products.
2. In certain embodiments, the recovered components can be used as a source of metals. Electronic components represent 30-35% of the weight of a typical motherboard, while the remaining 65-70% of the weight is attributable to the bare board. As the bare board does not contain any precious metals in most cases, substantially all of the precious metals will be concentrated in 30-35% of the board's weight after removal of the electronic components. Accordingly, the method for recovery of electronic components from PWBs can be part of a method for the concentration of precious metals in PWB recycling, in some embodiments.

One set of embodiments relates to a process for treatment of PWBs. The PWBs can be conveyed into a heating vessel containing a liquid heat medium at a temperature higher than the melting temperature of the solder. Subsequently, the solder can melt and the electronic components can be detached from the surface of the PWBs by gravity and optionally by the use of an external force. In some embodiments, the bare boards and the recovered electronic components are then taken out of the heating vessel, rinsed, and/or dried. In some embodiments, the solder can then be recovered from the liquid heat medium by recirculation and cooling down to the temperature lower than the melting temperature of the solder. In some such embodiments, so the solder can be at least partially separated from the liquid heat medium using any solid-liquid separation technique. Optionally, if a temperature higher than the melting temperature of solder is required to undermine or otherwise remove underfill used to attach some electronic components to the surface of PWBs, the PWBs with such remaining components attached by underfill can be removed from the heating vessel and forwarded to a second heating vessel, in which the temperature is set to a value that allows for the thermal destruction of the underfill, allowing for the detachment of the electronic components from the PWBs.

One set of embodiments relates to the development of a method for the detachment of electronic components from the surface of PWBs by melting the solder, whereby the electronic components are liberated from the bare boards, and, in some embodiments, both the bare boards and the electronic components can be further separately treated for metals recovery. For example, bare boards can be recovered for copper recycling, according to some embodiments. The application of certain embodiments affects substantially exclusively the solder and does not lead to any damage/deplating/loss of precious metals plating.

Certain embodiments are related to a method for concentrating precious metals, whereby PWBs serve as the input material and the recovered electronic components serve as the material in which precious metals are present in a concentrated form.

Some embodiments are related to a method for the recovery of electronic components in a substantially undamaged and working condition.

One set of embodiments is related to a process for the recovery of solder, whereby the solder is reclaimed in the form of a solid metal alloy having the chemical composition equal (or nearly equal) to the chemical composition of the solder applied during the manufacture of PWBs. The recovered solder can be re-used for re-tinning of the recovered electronic components or recycled for metals value.

Certain embodiments are related to a liquid heat medium which can be safely used (in association with certain embodiments) to reduce or minimize heat losses during the process and to accomplish easy separation of the recovered molten solder by cold filtration. The liquid heat medium can be re-used essentially indefinitely, in certain embodiments, generating substantially no waste.

Some embodiments are related to a method of providing very uniform heating of PWB elements through a liquid heat medium, whereby creation of any hot spots and overheating of any material is inhibited or avoided. In certain instances, if such overheating and/or hot spot generation within the PWBs and/or PWB components (which can contain brominated flame retardants, which can be released by thermal decomposition of plastics) is not avoided, dangerous gaseous emissions can be formed. Certain embodiments involve the reduction or elimination of such dangerous emissions.

Certain embodiments are related to a high-speed, effective, and economically efficient process, which can be applied for recycling any type of PWB and/or for recovery of working electronic components, for example, attached to the surface of PWBs with the solder using surface mount, through-hole, ball grid array (BGA), flip-chip, other known types of connections, and/or other later-developed connection technology.

One set of embodiments is related to a green and environmentally friendly process, which employs a non-toxic, non-hazardous liquid heat medium. In some embodiments, the application of the non-toxic, non-hazardous liquid heat medium leads to the creation of little or no hazardous emissions, liquid effluents, and/or dangerous byproducts.

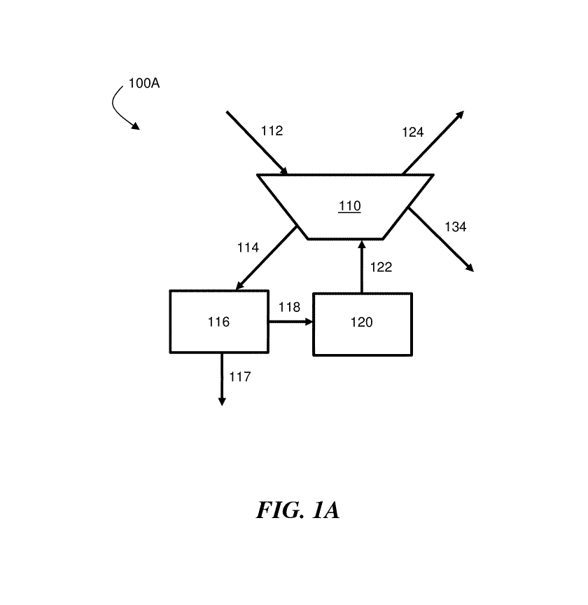

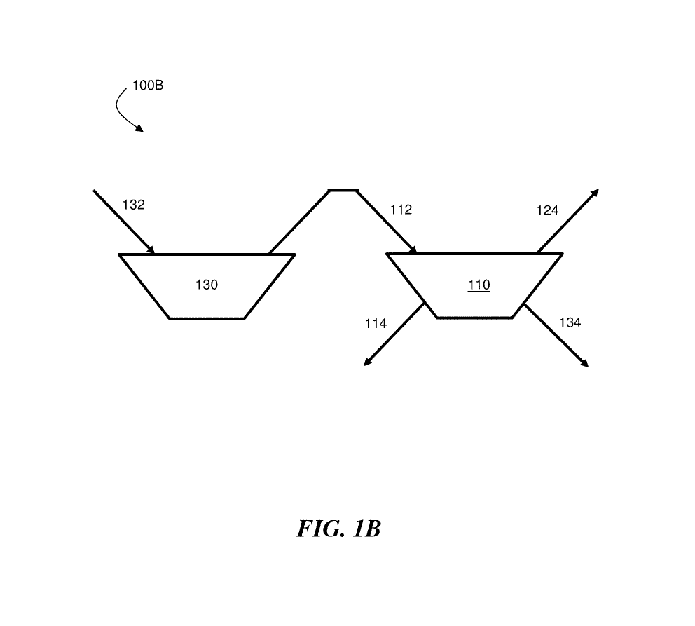

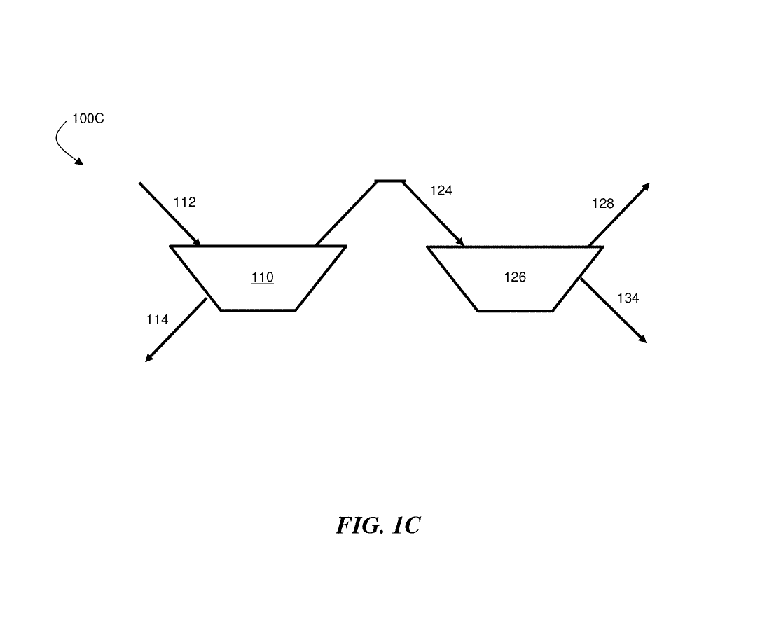

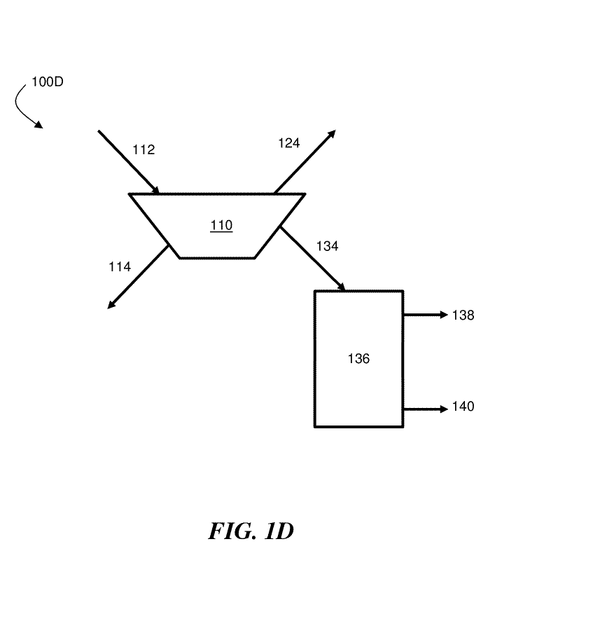

FIGS. 1A-1D are exemplary schematic diagrams illustrating various inventive features that may be present, alone or in combination, in certain of the systems and methods described herein. In system 100A of FIG. 1A, PWBs on which electronic components are attached can be immersed in a liquid heat medium within vessel 110. For example, in certain embodiments, the PWBs may be transported along pathway 112 and subsequently immersed in the liquid heat medium within vessel 110. Immersing the PWBs in the liquid heat medium can result in the removal of solder from the surfaces of the PWBs.

In one set of embodiments, at least a portion of the solder can be removed from the liquid heat medium and at least a portion of the liquid heat medium can be recycled. For example, in FIG. 1A, after the solder has been at least partially melted within vessel 110, at least a portion of the solder can be transported out of vessel 110, for example, within stream 114. In some such embodiments, at least a portion of the liquid heat medium may also be transported out of vessel 110 via stream 114. In certain embodiments, the solder and the liquid heat medium can be at least partially separated in unit 116 (e.g., a filtration unit such as a cold filtration unit, described in more detail below). In some such embodiments, at least a portion of the separated solder can be recycled to vessel 110, for example, within stream 118. In certain embodiments, the liquid heat medium within stream 118 can be reheated, for example, using heater 120, after which the liquid heat medium can be transported to vessel 110 via stream 122. At least a portion of the solder that has been separated from the liquid heat medium can be removed from the system, in certain embodiments. For example, at least a portion of the solder than has been separated from the liquid heat medium can be transported out of system 100A via stream 117. In some embodiments, PWBs from which at least a portion of the electronic components have been removed can be removed from vessel 110 via stream 124. In some embodiments, electronic components that have been removed from the PWBs can be removed from vessel via stream 134.

In certain embodiments (including those in which liquid heat medium recycling is performed and those in which liquid heat medium recycling is not performed), the PWBs may be immersed in a first liquid heat medium within a first vessel at a first temperature, and immersed in a second liquid heat medium within a second vessel at a second temperature that is higher than the melting temperature of the solder such that the solder is melted. For example, referring to system 100B of FIG. 1B, in certain embodiments, PWBs may be immersed within a first liquid heat medium within first vessel 130, for example, by transporting the PWBs along pathway 132. The liquid heat medium within vessel 130 may be used to pre-heat the PWBs, in certain embodiments, such that they are not subject to thermal shock prior to being transported into a hotter liquid heat medium. In some embodiments, the PWBs may be subsequently immersed in a second liquid heat medium, for example, within second vessel 110. In certain embodiments, the PWBs may be transported from first vessel 130 to second vessel 110 via pathway 112. In certain embodiments, the temperature of the first liquid heat medium within first vessel 130 can be between, for example, about 20% and about 80% of the temperature of the liquid heat medium within second vessel 110, when the first and second temperatures are expressed in degrees Celsius.

As noted above, in certain embodiments, the PWB on which solder has been formed is immersed in a liquid heat medium at a temperature equal to or higher than the melting temperature of the solder, which may allow the solder to melt. The solder removal step may allow for the detachment of at least a portion of the electronic components from the PWB. In some embodiments, some or all of the electronic components may be attached to the PWB using an underfill. Generally, the term “underfill” is used herein to refer to non-solder components that are used to attached electronic components to PWBs. In some embodiments, underfill can be polymeric, including thermoset polymers, thermoplastic polymers, or any other type of polymer that can be used to attach electronic components to PWBs. In some embodiments, the underfill comprises a glue. In some embodiments, the underfill may at least partially surround (and, in certain embodiments, encapsulate) the electronic components on the PWB.

In certain embodiments (including those in which liquid heat medium recycling and/or PWB pre-heating are performed and/or those in which liquid heat medium recycling and/or PWB pre-heating are not performed), the PWB to which components have been attached using an underfill can be submerged in an additional liquid heat medium (e.g., in an additional vessel) at a temperature sufficiently high to result in removal of the underfill. For example, referring to system 100C of FIG. 1C, after the PWBs are immersed in the liquid heat medium of vessel 110, the PWBs may be transported along pathway 124 and submerged within a liquid heat medium within vessel 126. The temperature of the liquid heat medium within vessel 126 may be sufficiently high to at least partially remove the underfill from the surfaces of the PWBs. In some such embodiments, the PWBs from which the electronic components have been removed can be transported out of vessel 126, for example, via stream 128. In certain embodiments, the electronic components that have been detached from the PWBs can be transported out of vessel 126, for example, via stream 134.

Electronic components can be detached from the surfaces of the PWBs via any suitable mechanism. For example, in certain embodiments, the electronic components can be detached from the surfaces of the PWBs due to gravity. Detachment by gravity can be enhanced or replaced by the action of any other force which may be used to separate the components and the bare boards, such as, for example, forces due to scrubbing, stripping, swiping, shaking, brushing, rolling, centrifuging, rubbing, blowing, spraying, pumping, recirculating, purging, sonication, rotation, and/or shearing.

When the surface of treated PWBs becomes free from electronic components, the bare boards can be removed from the liquid heat medium.

In some embodiments (including those in which liquid heat medium recycling, PWB pre-heating, and/or underfill removal are performed and/or those in which liquid heat medium recycling, PWB pre-heating, and/or underfill removal are not performed), after the electronic components have been removed from the PWBs, the detached electronic components can be sorted, for example, according to size, density, and/or an optical characteristic (and, in certain embodiments, sent for further treatment). Such separation can be useful to achieve a variety of goals. In certain embodiments, such separations may be used to group the electronic components into two or more streams such that the electronic components within each stream have similar material content (e.g., similar in type and/or quantity). For example, such separations can be used to separate components containing relatively large amounts of precious metals (e.g., at least about 500 mg per kg of electronic component mass or at least about 1000 mg per kg of electronic component mass) from components which do not, effectively concentrating the precious metals. As one particular example, components containing large amounts of silver and palladium can be sorted into a single stream. Such separation may be used, in some embodiments, to group electronic components according to downstream processing operations to which they will be subjected (e.g., to facilitate metals recovery).

In system 100D of FIG. 1D, for example, electronic components can be transported out of vessel 110 via stream 134 to sorter 136. In FIG. 1D, vessel 110 and sorter 136 are illustrated as discrete pieces of equipment, and detached electronic components are first transferred out of vessel 110 prior to being separated from each other within sorter 136 (and, in certain such embodiments, separated from the liquid heat medium within vessel 110 prior to being transferred to sorter 136). In some embodiments, however, sorter 136 can be attached to or otherwise integrated with vessel 110. In certain such embodiments, the detached electronic components may remain within the liquid heat medium within vessel 110 as the electronic components are being separated from each other using sorter 136. Such arrangements can be constructed, for example, by placing one or more screens within vessel 110. While FIG. 1D illustrates a set of embodiments in which the electronic components removed from vessel 110 are sorted, electronic components removed from an underfill removal vessel (e.g., vessel 126 in FIG. 1C) may also be sorted, in certain embodiments.

In some embodiments, the detached electronic components are at least partially separated from each other according to sizes of the electronic components. Sorter 136 may comprise, for example, at least one screen, which can be used to at least partially separate the incoming electronic components into two or more output streams. For example, in FIG. 1D, sorter 136 can be configured such that at least a portion of the electronic components are passed through at least one screen. The screening step can result in the separation of a first portion 138 of electronic components having a first average size from a second portion 140 of electronic components having a second average size that is smaller than the first average size. In addition, in certain embodiments, separating the electronic components by size comprises passing at least a portion of the electronic components through at least two screens, which can result in the production of three or more streams of electronic components of varying sizes. In certain embodiments, the screen(s) can be vibrated during the electronic component separation step. Vibrating the screens can enhance the efficiency with which the electronic components are separated from each other.

In some embodiments, the detached electronic components are at least partially separated from each other according to the densities of the electronic components. In some such embodiments, the process can result in the separation of a first portion 138 of electronic components having a first average density from a second portion 140 of electronic components having a second average density that is greater than the first average density.

In some embodiments, at least partially separating the detached electronic components from each other according to their densities comprises arranging the detached electronic components on a vibrating surface. In some such embodiments, the surface can be tilted such that the surface comprises a relatively high edge and a relatively low edge. In some embodiments, as the surface is vibrated, less dense components remain close to the high edge while the denser components travel across the surface toward the lower edge of the surface. In certain embodiments, the vibrating surface can be part of a “shaking table” (also sometimes referred to as a “table concentrator”). Exemplary shaking tables suitable for use include, but are not limited to, MD Gemini shaking tables available from Mineral Technologies, St Augustine, Fla.; shaking tables available from Henan Hongxing Mining Machinery Co., Ltd., Zhengzhou, China; and similar.

In certain embodiments, at least partially separating the detached electronic components from each other according to their densities comprises adding the electronic components to a liquid in which one portion of the electronic components float and another portion of the electronic components sink. For example, the electronic components can be mixed with a liquid (a “separating liquid”) having a density that is greater than the densities of one portion of the electronic components and less than the densities of another portion of the electronic components. In some such embodiments, the electronic components having densities lower than the separating liquid can float to the top of the separating liquid while electronic components having densities greater than the separating liquid can sink through the separating liquid. The lower density electronic components can subsequently be separated from the higher density electronic components. In some embodiments, multiple such separation steps can be performed (e.g., using two or more settling liquids) to produce three, four, five, or more fractions of electronic components.

The separating liquid can comprise, for example, [H₂W₁₂O₄₀]⁶⁻ polyanions. In some embodiments, the separating liquid comprises sodium polytungstate (SPT), sodium metatungstate (SMT), lithium metatungstate (LMT), and/or lithium heteropolytungstate (LST) (e.g., in solubilized form). Such materials can be used to prepare water-based solutions with densities of, for example, up to about 3 g/cm³, or more. In some embodiments, tungsten carbide can be added, for example, to further increase the density of the solution. Suitable separating liquid materials can be obtained from, for example, Geoliquids (Chicago, Ill.). While the use of the above-mentioned separating liquid materials can be advantageous in certain embodiments, it should be understood that other separation liquid materials could be used. For example, separation liquids comprising bromoform, tetrabromoethane (TBE), and/or methylene iodide could be used in certain embodiments, although some such liquids may be undesirable for use in certain applications due to potential adverse health effects.

Certain embodiments involve the selection of an appropriate amount of solute (e.g., a solute comprising [H₂W₁₂O₄₀]⁶⁻ polyanions) and/or solvent (e.g., water) to produce a solution having a density suitable for at least partially separating electronic components according to their densities. For example, an amount of solute and solvent can be selected to produce a separating liquid having a density between the densities of the electronic components within a first portion and the densities of the electronic components within a second portion. In one particular example, the separating liquid can be configured to have a density of, for example, from about 2.5 to about 3.5 g/cm³ (e.g., by adjusting the amount of solute such as sodium polytungstate within an aqueous solution). Plastic-containing electronic components (which may, for example, also contain gold) may have densities of, for example, less than 2.5 g/cm³ (e.g., about 1 g/cm³). Accordingly, the plastic-containing components may float to the top of the separating liquid. In contrast, ceramic-containing components (e.g., ceramic chips) may have densities of, for example, greater than 3.5 g/cm³ (e.g., about 4 g/cm³). Accordingly, the ceramic chips may sink to the bottom of the separating liquid. Subsequently, the plastic-containing electronic components may be separated from the ceramic chips, for example, by skimming the plastic-containing electronic components from the top of the separating liquid.

In certain embodiments, the detached electronic components are at least partially separated from each other according to optical characteristics of the electronic components. In some such embodiments, the process can result in the separation of a first portion 138 of electronic components having a first optical characteristic from a second portion 140 of electronic components having a second optical characteristic. The optical characteristic may correspond to, for example, a color, a shape, a transparency (e.g., a degree of transparency), or any other suitable optical characteristic.

In some embodiments, at least partially separating the detached electronic components from each other according to their optical characteristics comprises using an optical sorter. The optical sorter may be programmed, for example, to recognize and/or sort electronic components based upon their color or other visible markings on the electronic components. Exemplary optical sorters that may be used include, but are not limited to, L-VIS™ and CIRRUS™ optical sorters available from MSS Inc., Nashville, Tenn. and optical sorters available from LLA Instruments GmbH, Berlin, Germany.

In certain embodiments, the detached electronic components can be at least partially separated from each other using a combination of two or more of the methods described herein. In some embodiments, a first separation step may be performed within the vessel containing the liquid heat medium used to detach the electronic components from the PWB. For example, a first separation step in which relatively small chips (e.g., those containing only Ag and Pd) are separated using a small screen can be performed. In some embodiments, after removal of the first fraction of components, the remaining components could be placed on a shaking table. In some such embodiments, electrolytic capacitors (which often have a cylindrical shape) can be separated by allowing the capacitors to roll to the bottom of the table while the remaining components remain at the top of the table. In some embodiments, the electrolytic capacitors can be further separated into multiple streams (e.g., a first stream containing less dense, aluminum-based capacitors and a second stream containing denser, silver- and/or tantalum-containing capacitors) using a dense separating liquid (e.g., any of the separating liquids described above). In some such embodiments, a separating liquid may be used to separate plastic-containing components from non-plastic-containing components (e.g., ceramic-containing components), for example, as described above.

In certain embodiments, the detached electronic components are recovered in working condition and/or are otherwise undamaged. The recovered electronic components may be, according to certain embodiments, re-used in the manufacture of one or more new PWBs. The electronic components can be re-used, in certain embodiments, after removing residues of the liquid heat medium from the electronic components and/or after re-tinning pins of the electronic components.

The systems and methods described herein can be used to remove components from whole PWBs and/or to remove components from shredded or otherwise deconstructed PWBs. The systems and methods described herein can be used to treat populated and/or unpopulated PWBs.

As introduced above with respect to FIG. 1A, certain embodiments involve removing at least a portion of the solder from the liquid heat medium after the solder has been removed from the PWB. During certain embodiments of the process, the molten solder is removed from the surface of treated PWBs, and the solder accumulates within the liquid heat medium (e.g., liquid heat medium within vessel 110) in the form of molten drops. In certain embodiments, the solder droplets are not miscible with the liquid heat medium, so they are present as a separate liquid phase. In some embodiments, solder can be recovered in its metallic form and without any substantial change in its initial composition. In some embodiments, when the liquid heat medium is cooled down to the temperature lower than the melting temperature of the solder, the solder solidifies. After the solder has solidified, it may be separated from the liquid heat medium by simple filtration, decanting, centrifuging or any other known or later-developed solid-liquid separation method. In some embodiments, the solder and the liquid heat medium can be separated to produce a solder-containing stream (e.g., stream 117 in FIG. 1A) that comprises at least about 75 wt %, at least about 90 wt %, at least about 95 wt %, or at least about 99 wt % solder. In certain embodiments, the solder and the liquid heat medium can be separated to produce a liquid heat medium-containing stream (e.g., stream 118 in FIG. 1A) that comprises at least about 75 wt %, at least about 90 wt %, at least about 95 wt %, or at least about 99 wt % liquid heat medium.

In certain embodiments, the solder is recovered in the form of a solid metal alloy. The solder metal alloy may have, in certain embodiments, a chemical composition that is substantially equal to the chemical composition of the solder prior to subjecting the PWB to the solder and/or component removal process. In some embodiments, the solder is recovered in the form of a solid metal alloy having a chemical composition substantially equal to a chemical composition of the solder used in the manufacture of the PWB.

In some embodiments, the liquid heat medium separated from molten solder can then be heated to the process temperature and recycled back to the processing vessel. In such a way, the accumulation of large quantities of molten solder during the process can be avoided, as the solder can be continuously removed from the recirculating liquid heat medium in the form of solid metal. In some such embodiments, the liquid heat medium can be continuously recirculated to and from the vessel in which solder removal is performed. Such operation can lead to significant advantages as the volatilization of dangerous metals can be reduced and/or avoided. In certain embodiments, such processes can be operated such that the loss of heat is minimized, as the liquid heat medium (e.g., within vessel 110) is only cooled down to the highest temperature which allows solder to solidify. For example, if the process temperature is 200° C. and the melting temperature of lead-tin solder is 183° C., the process of cold filtration can be conducted at or near a temperature of just under 183° C. Of course, the cold filtration step may be carried out at any temperature that allows the solder to solidify. For example, in instances in which the solder melts at 183° C., the cold filtration step may be carried out at any temperature lower than 183° C. (e.g., at 182° C., at 175° C., or any other temperature). In certain embodiments, the liquid heat medium is cooled from the liquid heat medium operation temperature (e.g., 200° C. in the example illustrated above) down to the cold filtration temperature (e.g., 175° C.) in order to recover the solid solder, and then heated from the cold filtration temperature (e.g., 175° C.) up to the liquid heat medium operation temperature (e.g., 200° C.) in order to be re-used in the process.

In certain embodiments, the liquid heat medium (e.g., the liquid heat medium that is used to melt solder and/or any other liquid heat medium used in the system) is selected such that it exists in a liquid form at temperatures equal to the melting temperature of solder or higher. The melting temperatures of solders used in the electronics industry generally vary from 183° C. (e.g., for standard lead-tin solder) up to 221° C. (e.g., for lead-free solders) and up to 320° C. (e.g., for high-lead solder). Generally, any liquid which keeps its liquid form at temperatures equal to the melting temperature of the solder, can be used as a liquid heat medium according to some embodiments. In certain embodiments, the liquid heat medium can be operated (e.g., during melting of the solder), at a temperature of at least about 183° C., at least about 185° C., at least about 190° C., at least about 200° C., at least about 250° C., at least about 300° C., or, in certain embodiments, at least about 320° C. (and/or, in certain embodiments, up to about 400° C.). In some embodiments, the liquid heat medium is operated at a temperature that is at least 1° C., at least 2° C., at least 5° C., or at least 10° C. hotter than the melting point of the solder that is removed from the PWB. In embodiments in which multiple solders are to be removed, the liquid heat medium can be operated at a temperature that is equal to, at least 1° C. hotter, at least 2° C. hotter, at least 5° C. hotter, or at least 10° C. hotter than the highest melting point of the solders that are to be removed from the PWB.

In some embodiments, the liquid medium (e.g., the liquid heat medium that is used to melt solder and/or any other liquid heat medium used in the system) has a high flash point (e.g., for security) and/or low viscosity, low evaporation rate, and/or low thermal oxidation rate at working temperatures (e.g., to reduce losses). In certain embodiments, the liquid heat medium has a flash point that is at least about 10° C. higher (e.g., between about 10° C. and about 50° C. or between about 10° C. and about 15° C. higher) than the melting point of the solder that is being removed. In cases where multiple types of solder are being removed, the liquid heat medium can be selected, in some embodiments, such that the flash point of the liquid heat medium is at least about 10° C. higher (e.g., between about 10° C. and about 50° C. or between about 10° C. and about 15° C. higher) than the highest melting point of the solders that are being removed. In some embodiments, the liquid heat medium has a flash point that is at least about 10° C. higher or at least about 25° C. higher (e.g., between about 10° C. and about 50° C. or between about 25° C. and about 50° C. higher) than the working temperature of the liquid heat medium (e.g., 225° C.) during operation of the system.

In certain embodiments, the liquid heat medium (e.g., the liquid heat medium that is used to melt solder and/or any other liquid heat medium used in the system) has a boiling point that is at least about 10° C. higher or at least about 25° C. higher (e.g., between about 10° C. and about 50° C. or between about 25° C. and about 50° C. higher) than the melting point of the solder that is being removed. In cases where multiple types of solder are being removed, the liquid heat medium can be selected, in some embodiments, such that the boiling point of the liquid heat medium is at least about 10° C. higher or at least about 25° C. higher (e.g., between about 10° C. and about 50° C. or between about 25° C. and about 50° C. higher) than the highest melting point of the solders that are being removed. In some embodiments, the liquid heat medium has a boiling point that is at least about 10° C. higher or at least about 25° C. higher (e.g., between about 10° C. and about 50° C. or between about 25° C. and about 50° C. higher) than the working temperature of the liquid heat medium (e.g., 225° C.) during operation of the system.

In certain embodiments, the vapors above the liquid heat medium (e.g., the liquid heat medium that is used to melt solder and/or any other liquid heat medium used in the system) can be at least partially removed, for example, using an exhaust system over the surface of liquid heat medium. In some embodiments, a blanket of inert or otherwise non-reactive gas (e.g., nitrogen, argon, helium) can be positioned over the surface of the liquid heat medium, so the vapors of the liquid heat medium do not accumulate over the surface.

The use of a liquid heat medium (e.g., a liquid heat medium that is used to melt solder and/or any other liquid heat medium used in the system) with a low evaporation rate and/or a low oxidation rate can be important for maintaining low processing costs. If the liquid heat medium oxidizes and/or evaporates quickly, it may be necessary to replenish it more often, which can be relatively expensive. In certain embodiments, the liquid heat medium is selected such that, during operation, less than about 15 wt % (e.g., between about 1 wt % and about 15 wt %) of the liquid heat medium is lost during a 24 hour cycle of exposure of the liquid heat medium to the working temperature.

The use of a liquid heat medium (e.g., the liquid heat medium that is used to melt solder and/or any other liquid heat medium used in the system) with a low viscosity can provide a variety of advantages. For example, it is often easier to establish an even temperature distribution with the low-viscosity fluids. In addition, it can be easier to transfer heat to immersed components (e.g., boards) if low-viscosity liquid heat media are used. The amount of liquid heat medium that remains on the PWBs after removal of the PWBs from the liquid heat medium is also lower when low-viscosity liquids are used, which can reduce loss of the liquid heat medium. Low viscosity fluids are also relatively easy to pump. In some embodiments, the viscosity of the liquid heat medium is about 15 mPa-s or less at the working temperature. In some embodiments, the viscosity of the liquid heat medium is about 15 mPa-s or less at a temperature of about 225° C.

In some embodiments, the density of the liquid heat medium (e.g., the liquid heat medium that is used to melt solder and/or any other liquid heat medium used in the system) at the temperature of operation (e.g., at about 225° C.) is less than about 3.8 g/cm³, less than about 3.5 g/cm³, less than about 3 g/cm³, less than about 2 g/cm³, or less than about 1 g/cm³.

In some embodiments, the liquid heat medium (e.g., the liquid heat medium that is used to melt solder and/or any other liquid heat medium used in the system) comprises a thermal liquid (also sometimes referred to as a heat transfer fluid). Thermal liquids are often used as heat transfer media in heat transfer systems and can be specifically engineered to maintain high thermo-physical stability at high temperatures. In certain embodiments, the liquid heat medium (which can be a thermal liquid) can have a thermal conductivity of at least about 0.1 W/mK at the working temperature of the liquid heat medium during operation of the system. In certain embodiments, the liquid heat medium has a thermal conductivity of at least about 0.1 W/mK at a temperature of about 225° C.

Optionally, small amounts of additives can be added to the liquid heat medium (e.g., the liquid heat medium that is used to melt solder and/or any other liquid heat medium used in the system) in order to improve the ability of the liquid heat medium to resist oxidative breakdown and/or to improve the heat transfer capabilities of the liquid heat medium. These additives can be selected to inhibit or prevent chemical reactions involving the liquid heat medium from occurring. Examples of oxidation inhibitor additives, which can be used, for example, to reduce or prevent the oxidation of hydrocarbons, include but are not limited to zinc dithiophosphates, aromatic amines, alkyl sulfides, and hindered phenols. Examples of phenolic material inhibitors are 2,6-di-tertiary-butylphenol (DBP) and 2,6-di-tertiary-butyl-4-methylphenol or 2,6-di-tertiary-butyl-para-cresol (DBPC).

Examples of liquid heat media which can be used according to the present invention (e.g., to remove solder, pre-heat PWBs, and/or to remove underfill) are: synthetic and natural oils, mineral oils, petroleum oils (e.g., those comprising paraffinic and/or naphthenic hydrocarbons), aromatics (e.g., those compounds comprising benzene-based structures and including the diphenyl oxide/biphenyl fluids, the diphenylethanes, dibenzyltoluenes, and terphenyls), vegetable oils, animal oils, polymeric organosilicon compounds and silicon oils, hybrid glycol fluids, natural and synthetic waxes and paraffins, molten salts, ionic liquids and mixtures thereof, as well as thermal fluids marketed under trademarked names like Dowtherm, Syltherm, Therminol, Duratherm, Calflo, Petro-Therm, Paratherm, Xcelpherm, Dynalene, and the like.

In certain embodiments, the liquid heat medium (e.g., the liquid heat medium that is used to melt solder and/or any other liquid heat medium used in the system) can be substantially free of particulate material (e.g., including less than 0.5 wt % of particulate material or substantially no particulate material), excluding particulate material originating from the PWBs or components of the PWBs.

Examples of solders that can be melted and/or removed from PWBs include those solders comprising Sn, Pb, Ag, Cu, Zn, Bi, Sb, Au, Si, and/or In. PWBs comprising leaded or lead-free solder can be treated. In certain embodiments, the solder contains Sn, optionally in combination with one or more of Pb, Ag, Cu, Zn, Bi, Sb, Au, Si, and/or In. In some embodiments, the solder contains Au and/or Si.

In some embodiments, the liquid heat media described herein can be used to achieve homogeneous heating of the electronic components, the PWBs, and/or the solder. Generally, an article is homogeneously heated if the temperature of the article does not vary by more than about 3° C. across the article.

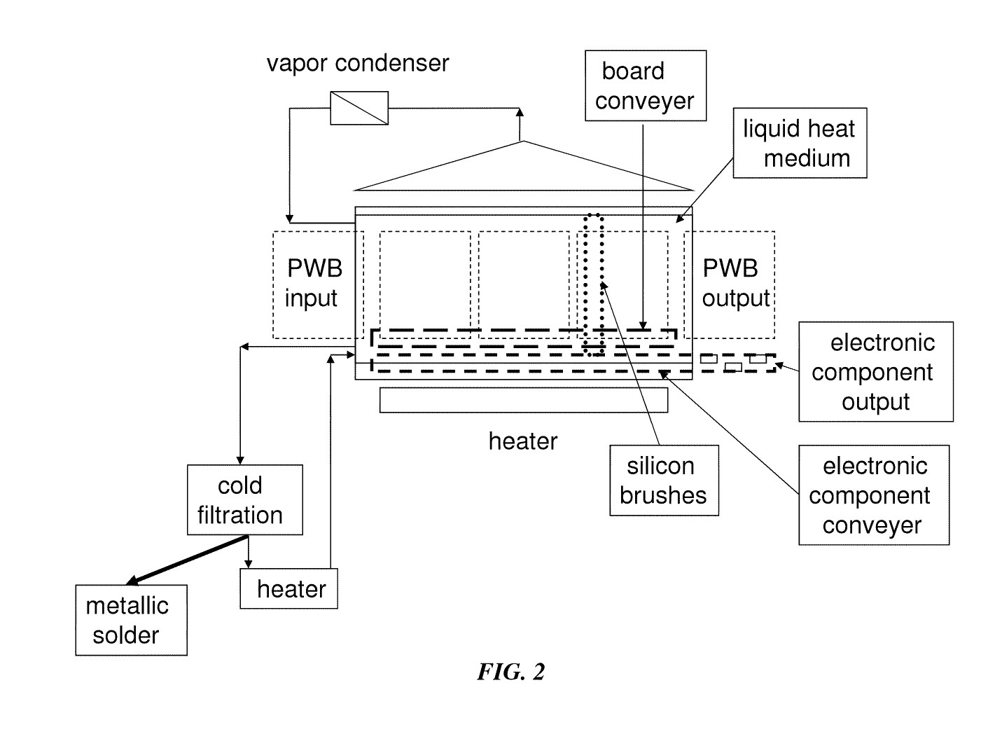

A schematic illustration of a desoldering process according to one set of embodiments is given in FIG. 2. According to the configuration illustrated in FIG. 2, PWBs are oriented vertically so that the desoldered electronic components fall off the bare board because of gravity when the solder melts. While the boards illustrated in FIG. 2 are oriented vertically, it should be understood that, in other embodiments, the boards can be oriented horizontally or in any other suitable orientation. In addition, while whole boards are illustrated in FIG. 2, it should be understood that, in other embodiments, shredded or otherwise deconstructed boards can be employed. The PWBs can have electronic components on one side or both sides. The action of gravity can be enhanced, in certain embodiments, by the application of a silicon brush or other mechanical instrument, for example, installed close to the end of the processing line, which can provide a swiping motion that can help to detach the electronic components from the surfaces of the PWBs. In FIG. 2, the PWBs can be placed on the conveyer line and enter the heating vessel from the top of the vessel. The contents of the vessel can be held at a relatively high temperature. In certain embodiments, the contents of the vessel can be held at a temperature of greater than about 222° C. (equal to or greater than, for example, 225° C.), to assure that the temperature of the vessel's contents is higher than the melting temperature of, for example, lead-tin solder (183° C.) and the melting temperature of, for example, lead-free solder (221° C.), so that melting of both types of solder can be achieved.

In certain embodiments, the sides of the vessel can be sloped such that the PWBs are covered gradually by the liquid medium as the PWBs descend into the vessel. The PWBs can be transferred to the vessel using a thermally resistant feeding tool. The residence time for the PWBs in the heating vessel can be adjusted by adjusting the speed of the conveyer so that all of the electronic components detach from the surface of the board by the time the board reaches the exit of the heated vessel. In certain embodiments, the solder melts before the point at which the PWB approaches the silicon brushes. The heaviest components can detach and fall down because of gravity before the board approaches the brushes.

The process illustrated in FIG. 2 includes a conveyer line on the bottom of the vessel, which transports the detached electronic components to the vessel's exit. In certain other embodiments, the liquid heat medium can be recirculated through a set of separators and/or screens, the first of which will capture the largest electronic components and will let the smaller components and the drops of molten solder to pass through, the next of which can separate smaller electronic components, and so on. The sizes of the openings within the separators/screens are generally dependent on the types of separations that are to be made. Typically, the components of the PWBs should be analyzed beforehand in order to determine which size separations would be most important. For example, if the smallest chips contain some silver and palladium and do not contain any other precious metals, it could be useful to select separators/screens having openings (e.g., 5 mm openings) that are capable of separating out the small components.

Finally, as soon as all the electronic components are separated from the liquid heat medium and the liquid heat medium contains only the drops of molten solder, this mixture can be forwarded to a separate vessel, in which the mixture can be cooled down to a temperature at which the molten solder can solidify. In embodiments in which both lead-free and leaded (e.g., lead-tin) solders are processed, in order to allow both lead-free and leaded (e.g., lead-tin) solders to solidify, the temperature in the cold filtration vessel can be kept, for example, at a relatively low temperature. In FIG. 2, the cold filtration vessel may be operated, for example, at about 175° C. In certain embodiments, the temperature within the cold filtration vessel can be equal to or less than about 182° C., equal to or less than about 180° C., or equal to or less than about 175° C. In certain embodiments, the cold filtration vessel can be operated at a temperature that is equal to or less than the melting point of the solder that is being removed (or, in certain embodiments, at a temperature at least 1° C., at least 2° C., or at least 5° C. colder than the melting point of the solder). In embodiments in which multiple solders are being removed, the cold filtration vessel can be operated at a temperature that is equal to or less than the lowest melting point among the plurality of solders (or, in certain embodiments, at a temperature at least 1° C., at least 2° C., or at least 5° C. colder than the lowest melting point of the solders).

The solid pieces of solder can be filtered out of the liquid heat media, and in this way they can be recovered. Subsequently, the thermal liquid may be heated from the lower temperature (e.g., about 175° C. or any temperature within the other ranges specified above, or at another temperature lower than the melting point of the solder(s)) up to the liquid heat medium process temperature (e.g., of 225° C.) and brought back to the heating vessel. The heaters can be selected such that they are capable of providing heat at a rate that produces re-heating of the liquid heat medium at a reasonable rate and to compensate heat losses during processing. The heaters can be configured such that the liquid heat medium contacts the hot surface of the heaters to provide heat exchange. In certain embodiments, it may be advantageous to produce a turbulent liquid flow near the heating surfaces of the heater(s) to provide intensive mixing and heat transfer. Fluid pumping can be achieved using, for example, centrifuge type pumps, which can be especially useful in transporting high volumes of hot fluids. In certain embodiments, fluid-cooled bearings and seals can be used in the pumps.

In general, the components of the system may be fabricated from materials capable of withstanding the high system temperatures, such as mild steel, stainless steel, nickel alloys, other temperature resistant metals, and other temperature-resistant non-metal materials. For example, a stainless steel vessel can be used to house the liquid heat medium used to perform the solder melting process. Stainless steel conveyor systems capable of withstanding such high temperatures are available from, for example, U.S. Tsubaki Power Transmission LLC, Wheeling, Ill. Separators/screens used to perform the electronic component separation step can also be made of any of the temperature-resistant materials mentioned herein, including stainless steel, mild steel, and the like. For example, stainless steel or mild steel screens (in the form of perforated sheets, assembled wires, or in any other suitable form) could be used.

In some embodiments, a vapor collection unit can be installed over the heating vessel in order to inhibit or prevent significant build-up of vapors of the liquid heat medium, which can be especially important if liquid heat media (e.g., thermal liquids) with low flash points are used in the process. In some cases it is advantageous to keep a light vacuum over the vessel in order to prevent oxidation of the liquid heat media. Sometimes a neutral gas blanket can be used for the same or similar purpose. In certain embodiments, the collected vapors can be condensed, recovered, and brought back to the heating vessel.

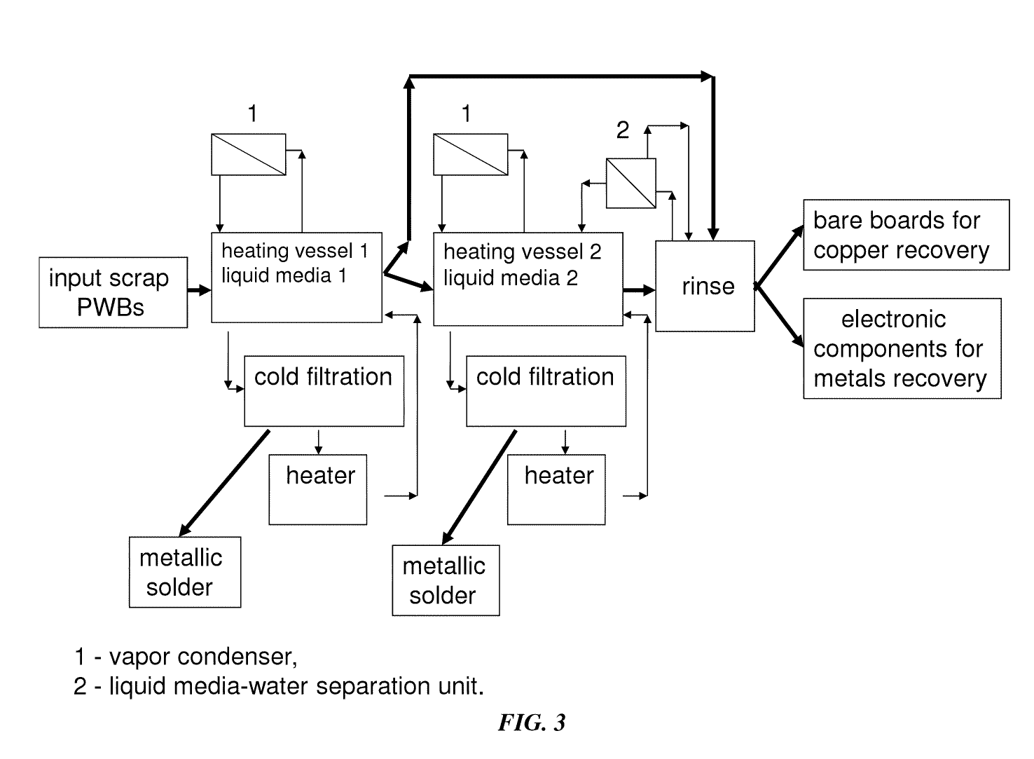

FIG. 3 is a schematic illustration of a process flow of a recycling operation. In FIG. 3, the electronic components may be collected separately from the bare PWBs and the solder, and can be used in the further recycling of metals. The bare PWBs can be made, for example, of copper clad laminate, typically being copper foils and fiberglass liners, glued together by epoxy. Such materials generally have high densities and are very difficult to grind. For at least this reason, the recycling methods based on grinding of PWBs are generally highly energy consuming, leading to fast equipment wearing and the loss of precious metals. On the other hand, if the bare PWB and the solder are separated from the electronic components by certain methods of the present invention, a significant amount of weight (e.g., more than about 50% of the initial weight of the PWB, in certain embodiments) can be removed from the waste material flow. In some such cases, precious metals could be subsequently recovered in more concentrated form in the electronic components fraction, which can be very advantageous in recycling applications. In cases in which PWBs have surface gold plating, the system can be configured such that the gold plating will not be damaged, removed, or otherwise affected by the employment of certain of the inventive methods described herein. In some embodiments, the bare boards having surface plating may be separated from the rest of the treated boards and subjected to any of a variety of conventional processes for recovery of precious metals plating (e.g., in a downstream process).

As shown in FIG. 3, the PWBs are loaded in the first heating vessel, in which the temperature of liquid heat medium is kept at a temperature at which the solder can be melted. For example, in certain embodiments, the temperature of the liquid heat medium within the first heating vessel is kept at about 225° C. or greater (or any temperature within the ranges outlined above in relation to the operation of the system in FIG. 2). Such temperatures are generally hot enough to cause melting of, for example, both tin-lead and lead-free solder. As a result, the electronic components fall onto the bottom of the heating vessel because of gravity and/or can be scrubbed from the surface of the PWBs by brushes, swipes, rollers, and the like.

In some embodiments, electronic components may be attached to PWBs using an underfill material (e.g., a non-solder underfill material, including certain encapsulant materials). Examples of such underfill materials that might be present on PWBs include, but are not limited to, epoxies such as Loctite® Hysol® and Loctite® Eccobond™, both of which are manufactured by Henkel. It is possible that, in certain cases in which the electronic components are attached to the surface of the PWBs using underfill, the electronic components may not be detached. For example, the temperature of 225° C. might not be sufficient to cause the destruction of the underfill polymer. The temperature required to facilitate removal of underfill generally depends on the type of polymer used (e.g., thermal setting polymer, thermally cured polymer, or other polymer types). The temperature needed to remove the underfill can be established experimentally. For example, in certain cases, the temperature needed to remove the underfill may be higher than 225° C. (e.g., 350° C.). In some such cases, the boards leaving the first heating vessel can be visually inspected. If the treated PWB does not contain any electronic components remaining on its surface (e.g., if it is completely bare), it can be forwarded directly to a rinsing operation. If there are any remaining electronic components on the surface of the treated PWB, it can be forwarded to a second heating vessel, the temperature of which may be kept high enough to remove or facilitate removal of underfill (e.g., glues, polymers, or other underfill materials) used to attach electronic components to the surface of the PWB. In certain embodiments, it is advantageous if only the boards containing underfill which cannot be removed by lower temperature within the first heating vessel are treated at a temperature higher than the temperature needed to melt solder (e.g., the temperature of the liquid heat medium used to remove underfill within the second vessel). In such cases, the PWBs from which electronic components have been removed in the first heating vessel will not unnecessarily be heated to higher temperatures, which can be harmful for plastic connectors and lead to plastics degradation, which can cause dangerous gaseous emissions.

In certain embodiments, different liquid heat media can be used within the various heating vessels described herein. For example, referring to FIG. 3, different liquid heat media can be used within heating vessel 1 and heating vessel 2. In some such embodiments, the liquid heat medium used in the second vessel can be selected to be more appropriate for working at higher temperatures than the temperature in the first heating vessel. Some underfills are manufactured to withstand relatively high temperatures (e.g., temperatures of 260° C. or higher). In some such embodiments, liquid media with flash points and/or boiling points higher than the melting temperatures of the underfill (e.g., at least about 10° C. higher or at least about 25° C. higher) can be employed. Examples of such liquid heat media include, but are not limited to, Calflo™ AF (Petro-Canada); Therminol® 75, Therminol® 72, Therminol® 66, and Therminol® 62 (Solutia); and Paratherm NF®, and Paratherm HR® (Paratherm).

In certain embodiments, vapor over the heating vessels may be collected, condensed, and brought back to the vessels. After the removal of electronic components, the bare boards and the electronic components can be rinsed and are subsequently ready for further recycling. The residues of the liquid heat medium can be separated from the rinse water and brought back to the heating vessel in order to minimize losses.

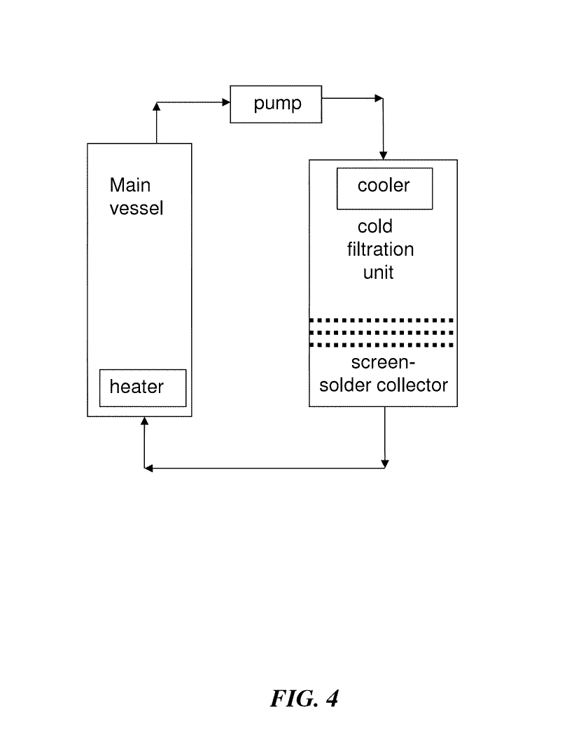

As mentioned above, in some embodiments, cold filtration can be used to recover solder. FIG. 4 is a schematic cross-sectional illustration of a system which can be used to perform cold filtration. As illustrated in FIG. 4, the liquid heat medium containing the solder is transported from the main vessel (with a working temperature of, for example, 225° C.) to a secondary vessel. The liquid heat medium containing the solder can be cooled, for example, over a filter or mesh (e.g., made of stainless steel). As the liquid heat medium is cooled (e.g., to a temperature below the melting point of the solder such as, for example, 175° C.), the solder can be solidified. The solidified solder can be trapped by the filter or mesh. The liquid medium may be subsequently transported through the filter or mesh and subsequently recycled to the main vessel. In some embodiments, the liquid is heated back to the working temperature of the main vessel (e.g., 225° C.) by the time the recycled liquid enters the main vessel.

It should be understood that the inventive systems and methods are not limited to the use of the cold filtration apparatus illustrated in FIG. 4, and in other embodiments, other solid/liquid separation techniques may be employed. For example, in some embodiments, solid solder can be separated from the liquid heat medium using other forms of filtration (optionally enhanced by applying a pressure gradient across the filter), decanting, centrifugation, and the like, in place of or in addition to the cold filtration processes described elsewhere.

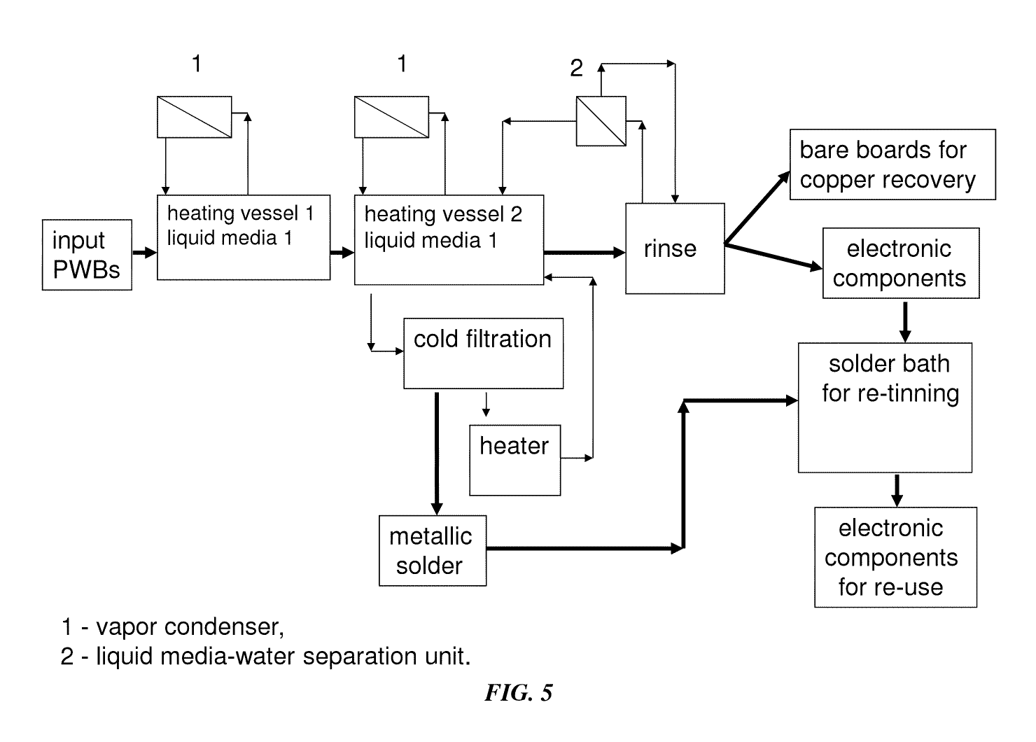

FIG. 5 is a schematic illustration of an exemplary process for the recovery of working electronic components from PWBs in which the PWBs are pre-heated. Heating PWBs up to the melting temperature of solder generally will not damage the electronic components if thermal shock is avoided, i.e. if heating is relatively slow. In order to avoid thermal shock, a first heating vessel can be used, in which the temperature is kept lower than the melting temperature of the solder (e.g., 125° C. in heating vessel 1 of FIG. 5). As illustrated in FIG. 5, the PWBs are immersed in the first heating vessel and pre-heated, for example, to assure that their temperature does not rise too fast.

The pre-heated boards may then be forwarded to the second heating vessel, in which the temperature of the liquid heat medium can be set relatively high (e.g., to 225° C.), for example, to assure melting of both tin-lead and lead-free types of solder.

In certain embodiments, the PWBs are pre-heated (e.g., within the first vessel) to a temperature, in ° C., that is between about 20% and about 80%, between about 40% and about 80%, or between about 60% and about 80% of the working temperature (e.g., 225° C.) of the liquid heat medium used to melt the solder (e.g., the liquid medium in the second vessel that receives the pre-heated boards). In some embodiments, the pre-heating step comprises heating the boards at a rate of equal to or less than about 2° C. per second.

In some embodiments, the electronic components fall from the bare board and can be recovered. If needed, the temperature can be kept higher than 225° C. for certain electronic components attached with glue or underfill. As described in association with FIGS. 2 and 3, the liquid heat medium can be recirculated through a “cold filter”, meaning that the temperature of the liquid heat medium drops down to a temperature which is lower than the melting temperature of the solder, and solder solidifies and is separated from the liquid by, for example, filtration. The cooled liquid heat medium (e.g., at 175° C.) may then be brought back to the second heating vessel and/or can be used to feed the first vessel with hot liquid heat medium. The separated electronic components may be rinsed, dried and forwarded to a re-tinning station, which can comprise, for example, a bath filled with molten solder (e.g., the same type of solder that was originally used to attach the electronic components to the PWB, or another type of solder). The pins of the recovered components can be immersed in the molten solder so that they are completely or nearly completely covered by the solder upon removal of the components from the molten solder. The solder then can be solidified and the components can be re-used. The bare boards can be, in certain embodiments, recycled, for example, to recover metals present on the bare boards.

The following examples are intended to illustrate certain embodiments of the present invention, but do not exemplify the full scope of the invention.

### Example 1

This example describes the use of a liquid heat medium to remove solder and electronic components from PWBs.

A heating vessel was built using a heat mantel with a temperature regulator wrapped around a cylindrical stainless steel vessel. Dynalene 600 thermal liquid was used as a liquid heat medium in the heating vessel. The temperature in the vessel was raised to 220° C., and a waste low grade motherboard was immersed into the hot liquid heat medium. The motherboard was kept in the heating vessel for 3 min and afterwards it was removed for inspection. Some electronic components had already detached from the motherboard's surface and were found on the bottom of the vessel. Light tapping resulted in removal of additional components. The board was immersed in the liquid heat medium for additional 2 min. The board was subsequently removed, and a silicon brush (IMU-71120 by Imusa USA, Doral, Fla.) was used to remove the remaining components from the surface of the motherboard. As a result, the motherboard was found to be completely barren of electronic components on its surface. The electronic components were removed from the liquid heat medium, the bare board and the components were allowed to cool down in open air and afterwards they were weighed. The liquid heat medium was cooled to room temperature so that the solder drops solidified. Subsequently, the solder drops were removed from the liquid heat medium by filtration and weighed.

The weights of the motherboard and its components before and after the desoldering operation are presented in Table 1.

TABLE 1
Mass of the treated waste low grade
motherboard and its components.

| | Mass, g | Weight % | Precious metals |
|---|---|---|---|
| Populated motherboard | 583.3 | 100 | Yes |
| Bare board | 211 | 36.2 | No |
| Electronic chips | 22.6 | 3.9 | Yes |
| Connectors and other components | 225.7 | 38.7 | Yes |
| Steel components not containing | 82 | 14.0 | No |
| any precious metals | | | |
| Recovered solder | 42 | 7.2 | No |

The desoldering operation resulted in separation of the materials that did not contain any precious metals from materials containing precious metals. In this way, the precious metals were recovered in a more concentrated form. The bare board, the steel components, and the solder did not contain any precious metals, and they together represented 57.4% of the initial mass of the motherboard. This material can be separated from the incoming material flow in the recycling operation and it can be removed from the recycling process with no additional operations required. On the other hand, traditional recycling methods apply size reduction to the total weight of the electronic waste, which requires much more energy and resources than the method described in this example (and in certain embodiments described elsewhere herein).

To determine the precious metals content, the electronic chips (22.6 g) and other electronic components such as resistors, capacitors, and plastic connectors (225.7 g) were ground in a laboratory ball mill cooled by liquid nitrogen. The two separate powder samples were subjected to a nitric acid leach followed by a two-hour leaching with boiling Aqua Regia. The concentrations of gold, palladium, and silver in the ground material are presented in Table 2.

TABLE 2
Concentration of precious metals in chips and components,
recovered from the treated waste low-grade motherboard.

| | Mass, g | Au, mg/kg | Pd, mg/kg | Ag, mg/kg |
|---|---|---|---|---|
| Electronic chips | 22.6 | 1395 | 260 | 3308 |
| Electronic components | 225.7 | 45 | 144 | 34 |

The electronic chips contained significantly higher concentrations of precious metals than the electronic components. Thus, the desoldering operation in this example resulted in the separation of a 3.9%-weight fraction containing high concentrations of precious metals, a 38.7%-weight fraction containing low concentration of precious metals, and a 57.4%-weight fraction containing no precious metals from a typical waste low grade motherboard.

### Example 2

A waste SCSI card was subjected to the desoldering operation described in Example 1. The weights of the SCSI card and its components are presented in Table 3.

TABLE 3
Mass of the treated SCSI card and its components.

| | Mass, g | Weight % | Precious metals |
|---|---|---|---|
| Populated SCSI card | 211 | 100 | Yes |
| Bare board | 114 | 54 | No |
| Electronic chips | 71.5 | 33.9 | Yes |
| Electronic connectors | 18.5 | 8.8 | Yes |
| Recovered solder | 7 | 3.3 | No |

The bare board did not contain any precious metals and represented 54% of the card's original weight. It is generally very advantageous to eliminate this weight from the material flow in a precious metals recycling operation; the bare board can be sent for copper recovery as it does not contain any other metals. Additionally, 3.3% of the original card's weight in the form of solder alloy was recovered, which can be also recycled for its metal value. The electronic chips (71.5 g) and the electronic connectors (18.5 g) were ground in a laboratory ball mill cooled by liquid nitrogen. The two separate powder samples were subjected to a nitric acid leach followed by a two-hour leaching with boiling Aqua Regia. The concentrations of gold, palladium, and silver in the ground material are presented in Table 4.

TABLE 4
Concentration of precious metals in chips and connectors,
recovered from the treated waste SCSI card.

| | Mass, g | Au, mg/kg | Pd, mg/kg | Ag, mg/kg |
|---|---|---|---|---|
| Electronic chips | 71.5 | 1018 | 839 | 4760 |
| Electronic connectors | 18.5 | 1710 | 790 | 52 |

The electronic connectors contained visible surface precious metals plating, so there was no need to grind them to get access to precious metals. The plastic connectors can be recovered separately from the ceramic electronic chips and the precious metals plating can be easily recovered from their surface by any suitable chemical method. As a result, only electronic chips, which represent 33.9% by weight of untreated SCSI card, need to be ground for precious metals recovery.

### Prophetic Example 3

This example describes a continuous process in which electronic chips and other electronic components can be removed and recycled from PWBs. A main working reservoir can be filled with liquid heat medium. Heaters associated with the main working reservoir can be switched on and pumps can start recirculation of the liquid heat medium inside of the working reservoir, resulting in fast heating of the volume of the liquid heat medium up to a working temperature of, for example, 225° C. The PWBs can be loaded into a feeding unit and the unit can be attached to a feed. The PWBs can be attached to clasps of the chain conveyer one by one and as movement of the conveyor is initiated, the boards can move forward and, at the same time, begin to be immersed in the hot liquid heat medium (because the conveyer is descending). As soon as the boards become completely immersed in the hot liquid heat medium, the conveyer can become horizontal. The boards can be moved inside of the working vessel at a speed which allows the solder to melt completely as soon as the board arrives close to the end of the horizontal section. Rotating silicone brushes can be installed on the sides of the main working reservoir at distances of ½ and ¾ of the length of the horizontal section; when rotating, the brushes provide a scrubbing effect from the two sides of the PWB, helping to remove the electronic components. The turbulent flow of recirculating liquid heat medium can hit the components and provides additional force serving to detach the components from the surface of the board. In this way, the boards which have arrived to the end of the horizontal section can be free of all the components from their surfaces and can be in the form of bare boards. The boards can then enter the upward section of the conveyer, being gradually removed from the hot liquid heat medium. The boards taken out of the liquid heat medium can continue their horizontal motion and enter a section in which an air knife is applied to blow away the residual liquid heat medium from the surfaces of the boards. The air carrying liquid heat medium and residues can be fed to a condenser, in which the liquid heat medium is collected and brought back to the working reservoir. After passing the air knife, the boards are sprayed with a cleaning liquid, which cleans liquid heat medium residues which were not removed by the air knife from the surfaces of the boards. In certain cases, the cleaning liquid preferably has a basic pH (e.g., a pH of 9-11). Any effective cleaning agent can be used, such as common detergents and special cleaning fluids (e.g., DiAqua sold by RPM Technology). As the boards exiting the process are hot, cold air can be used for the air knife, in certain embodiments. In addition, the cleaning liquid can be recirculated and cooled. The vapors of the cleaning liquid can be collected, condensed, and brought back to the cleaning liquid reservoir. As the final step, the boards can be dried, detached from the clasps, and removed from the process. The collected boards can be transferred out for copper recycling. The vapors collection unit (which can have a variable flow rate) can be installed over the open working surface of the liquid heat medium so that the vapors are captured, condensed and brought back to the working reservoir.

The electronic components detached from the surface of the PWBs can be collected on the bottom of the working reservoir, which can have a V-shaped bottom. When such reservoirs are used, the components will generally collect at the lowest point of the bottom of the reservoir. A removable cylindrical section (i.e., a chip removal section) can be attached to the lowest point of the bottom of the working reservoir so that the detached components accumulate in the upper portion of the cylindrical section. The chip removal section can contain several different mesh screens along its height, so that the screen with the largest openings is installed at the highest level, and the screen having the smallest openings is installed at the lowest level. The highest screen will retain only the largest components; the rest of the components will drop down onto subsequent screens having smaller mesh sizes (and which will retain smaller components than the first screen) allowing smaller components to pass down to smaller meshes. The screen mesh sizes can be chosen in such a way that the electronic components can be separated by size in preferred categories, for example, categories based on metals content and/or after-treatment steps. The liquid heat medium can be pumped through the cell providing with forced filtration of the components from the liquid. As soon as the components collection unit becomes filled with the removed electronic components, the recirculation pump can be stopped, the bottom of the working vessel can be closed and separated from the collection unit, the collection unit can be opened, and the separated electronic components can be removed and sent for further treatment/separation.

The smallest screen of the collection unit can be configured to retain all the smallest components and can be configured to allow only the hot liquid heat medium and the molten solder to pass through it. After passing through the components separation unit, the hot liquid heat medium can be brought back to the working vessel. The molten solder detached from PWBs can accumulate within the volume of the liquid heat medium and can be separated. To achieve this, a portion of the liquid heat medium which passed through the components separation unit can be pumped into a cold filtration unit for solder removal. In certain embodiments, the flow rate for solder removal is lower than the flow rate of recirculation through the components separation unit as solder accumulates in the volume of the working liquid heat medium relatively slowly. The partial flow taken to the solid filtration unit is pumped into this separate reservoir, which can be operated at a relatively cool temperature (e.g., 175° C.), for example, by using a cooler. The solder can be solidified, and the liquid heat medium containing solid solder particles can be pumped through a screen, which retains the solid solder particles and lets the liquid heat medium pass through. The separation screen can be mounted in a removable element, in which the solid solder accumulates and which is removed and liberated from liquid heat medium as needed. The liquid heat medium liberated from the solder, now having a relatively low temperature (e.g., 175° C.), can be pumped back to the working reservoir, in which it is re-heated to the working temperature.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A process for the removal of electronic components attached to a surface of a printed wire board (PWB) with solder, comprising:
immersing the PWB in a liquid heat medium within a vessel at a temperature higher than the melting temperature of the solder such that the solder is melted,
transporting at least a portion of the liquid heat medium and at least a portion of the solder out of the vessel,
at least partially separating the solder from the liquid heat medium, and
recycling at least a portion of the liquid heat medium to the vessel.

2. A process for the removal of electronic components attached to a surface of a printed wire board (PWB) with solder and an underfill, comprising:
immersing the PWB in a first liquid heat medium within a first vessel at a temperature higher than the melting temperature of the solder such that the solder is melted, and
immersing the PWB in a second liquid heat medium within a second vessel at a temperature sufficiently high to remove the underfill.

3. A process for the removal of electronic components attached to a surface of a printed wire board (PWB) with solder, comprising:
immersing the PWB in a first liquid heat medium within a first vessel at a first temperature, and
immersing the PWB in a second liquid heat medium within a second vessel at a second temperature that is higher than the melting temperature of the solder such that the solder is melted,
wherein the first temperature is between about 20% and about 80% of the second temperature, when the first and second temperatures are expressed in degrees Celsius.

4. A process for the removal of electronic components attached to a surface of a printed wire board (PWB) with solder, comprising:
immersing the PWB in a liquid heat medium at a temperature higher than the melting temperature of the solder, such that the solder melts and the electronic components detach from the surface of the PWB; and
at least partially separating the detached electronic components from each other according to sizes, densities, and/or optical characteristics of the electronic components.

5. (canceled)

6. A process according to claim 1, wherein the solder comprises Sn, Pb, Ag, Cu, Zn, Bi, Sb, Au, Si, and/or In.

7. (canceled)

8. A process according to claim 1, wherein:
the liquid heat medium is at least partially recycled, and
at least a portion of the molten solder is separated from the liquid heat medium by cooling the liquid heat medium containing the molten solder down to a temperature lower than a melting temperature of the solder.

9. A process according to claim 8, wherein at least a portion of the solder solidifies and is at least partially separated from the liquid heat medium.

10. (canceled)

11. A process according to claim 1, wherein the liquid heat medium has a flash point that is at least about 10° C. higher than a melting temperature of the solder.

12. (canceled)

13. A process according to claim 1, wherein the liquid heat medium comprises a synthetic oil, a natural oil, a mineral oil, a petroleum oil, a paraffinic hydrocarbon, a naphthenic hydrocarbon, an aromatic compound, a vegetable oil, an animal oil, a polymeric organosilicon compound, a silicon oil, a hybrid glycol fluid, a natural and/or synthetic wax and/or paraffin, a molten salt, and/or an ionic liquid.

14-15. (canceled)

16. A process according to claim 1, wherein the PWB is separated into a first material stream comprising recovered solder, a second material stream comprising the recovered bare board, and a third material stream comprising recovered electronic components.

17-20. (canceled)

21. A process according to claim 1, wherein the separated electronic components are recovered in working condition and/or are otherwise undamaged.

22-28. (canceled)

29. A process according to claim 4, wherein the detached electronic components are at least partially separated from each other according to sizes of the electronic components.

30. A process according to claim 4, wherein at least partially separating the electronic components from each other according to sizes of the electronic components comprises passing at least a portion of the electronic components through at least one screen.

31-33. (canceled)

34. A process according to claim 1, wherein the PWB is transported to a second heating vessel filled with a second liquid heat medium at a temperature higher than the melting temperature of the solder.

35. (canceled)

36. A process according to claim 1, wherein the PWB is pre-heated, prior to submerging the PWB in the liquid heat medium.

37. A process according to claim 36, wherein the PWB is pre-heated at a rate of equal to or less than about 2° C. per second.

38. A process according to claim 4, wherein the detached electronic components are at least partially separated from each other according to densities of the electronic components.

39. A process according to claim 38, wherein at least partially separating the detached electronic components from each other according to densities of the electronic components comprises arranging the detached electronic components on a vibrating surface.

40. A process according to claim 38, wherein at least partially separating the detached electronic components from each other according to densities of the electronic components comprises adding the electronic components to a liquid in which one portion of the electronic components float and another portion of the electronic components sink.

41. A process according to claim 4, wherein the detached electronic components are at least partially separated from each other according to optical characteristics of the electronic components.

42. (canceled)
